(19) United States
(12) Patent Application Publication
(10) Pub. No.: US 2006/0040244 A1
(43) Pub. Date: Feb. 23, 2006

(54) Personal fitness system

(76) Inventor: Meira Kain, Kfar Aviv (IL)

Correspondence Address: Dekel Patent Ltd.;Beit HaRofim, 18 Menuha VeNahala Street, Room 27, Rehovot, IL

(21) Appl. No.: 10/921,155

(22) Filed: Aug. 19, 2004

(51) Int. Cl. G09B 9/00; G09B 19/00

(52) U.S. Cl. 434/247

(57) ABSTRACT

A method for operating a physical fitness program, including providing an animated database containing graphical images of a physical fitness program, at least some of the graphical images including animated characters, and creating a sequence of the graphical images in accordance with real-time interaction with a user as a function of user preferences and capabilities. Audio content may be created along with the sequence of graphical images. The sequence of the graphical images may be displayed on a display screen, or may be recorded on a recording medium.

### FIELD OF THE INVENTION

The present invention relates generally to personalized training or fitness systems, and particularly to a personalized fitness program based, without limitation, upon an analysis of a user's health and fitness levels, individual preferences, habits, available equipment and goals, and other factors.

### BACKGROUND OF THE INVENTION

Personalized training or fitness systems are known. For example, U.S. Pat. Nos. 6,503,173 and 6,527,674 to Clem describe a personalized training system, which includes a fitness device, into which a user enters a first plurality of user information, including a choice of an automated interactive learned program mode or an automated fitness test mode. An automated control location receives the first plurality of user information, and a second plurality of user information during each use of the fitness device by the user. A performance assessor assesses a performance of the user based on a comparison of the second plurality of user information to the first plurality. A performance database is incrementally formed by the performance assessments, and a fitness comparator adjusts the use based on a comparison of the performance database to the second plurality of user information.

Clem has another U.S. Pat. No. 6,053,844, which describes an exercise system including an exercise device at a user location includes a controller at the user location for controlling the exercise device. A control location remote from the user location and a communication system for transmitting information between the exercise device and the control location are provided. A sensor at the user location determines user location information and applies the user location information to the communication system for transmission to the control location. Control information is applied to the communication system by the control location in response to the user location information for transmission to the controller to control the exercise device according to the control information. Thus, the present invention is an interactive fitness system for permitting a user of a programmable exercise device to interact with a fitness server device while the user is in a location remote from the fitness server device. For example, the user can interact with the fitness server device from the home of the user. Using the system of the present invention the user can download new fitness equipment programs for controlling the exercise equipment. The user can also interact with fitness experts on-line and provide exercise information and receive control information wherein the received control information can permit interaction between the fitness server device and the user.

PCT Published Patent Application WO0116855 describes a personalized health, nutrition, and fitness data delivery system that operates over multiple interactive platforms, and that is synchronized via the World Wide Web. Aside from conventional printing capabilities, the fitness training system works with multiple interactive electronic devices such as the Palm Pilot and the VitalWatch, which is a wrist based, Web-enabled personal trainer. A key feature of the system is the GetFit.com Web site which houses intelligent technology, along with a complete set of software tools used to create and manage fitness programs and transfer them to and from a portable device, such as the Palm Pilot or VitalWatch. The site also provides its visitors with a rich interactive experience where they can educate themselves on proper fitness training techniques and nutrition, and communicate with other users who have similar interests.

U.S. Published Patent Application 2002107433 to Mault describes a system and method of health management using a personal fitness trainer and interactive television. The system includes an entertainment device, a control means, a remote control device, and an interactive television network in communication with the control means via a communication network. The system also includes a computer system in communication with the interactive television network, and the interactive television network transmits a signal representing a personal fitness training program for the user that is processed and displayed on the display screen of the entertainment device so that the user can interactively participate in the personal fitness training program. The method includes the steps of the user selecting the personal fitness training program using the remote control device and selecting a transactional selection from a predetermined list for the personal fitness training program displayed on the display screen for the entertainment device. The method also includes the steps of the interactive television network processing the selection and displaying the appropriate information on the display screen of the entertainment device. The method further includes the step of the user interactively participating in the program via the interactive television network.

### SUMMARY OF THE INVENTION

The present invention seeks to provide a novel physical fitness program, as is described more in detail hereinbelow.

The present invention is a departure from prior art health and fitness TV video programs, CDs and DVDs. Contrary to the prior art that provides a “one size fits all” workout program, the present invention has an innovative platform capable of creating a one of a kind, personalized fitness program, which may be created by analyzing the user's health and fitness levels, individual preferences, habits, available equipment and goals, amongst other parameters (the list being non-limiting). The personalized fitness program may comprise, without limitation, weight lifting, cardio-vascular conditioning or stretching exercises.

The present invention may provide an animated database that serves as a state-of-the-art personal trainer. In accordance with an embodiment of the invention, the way each movement should be accomplished correctly is depicted graphically and audibly. By focusing graphically and verbally on each exercise, the user may become aware of the intricate and precise movements the body is capable of performing. Mastering correct movements not only may prevent injuries, but also provide an incentive to maintain the fitness regime. The animated database may comprise a three-dimensional animated graphic library and database that enables instant adjustments to the fitness program.

The present invention may display the graphical images of the fitness program on a display screen (PC, play station, game console, etc.). Additionally or alternatively, an exercise and fitness video or DVD may be created. In creating the interactive fitness video or DVD, the user may choose the language, music, animated character and other settings, for example.

In accordance with an embodiment of the invention, an interactive home fitness evaluator and progress log recorder may be provided. The performance and progress of the user may be monitored with biosensors, such as but not limited to, pulse sensors, CO₂ sensors, blood pressure sensors and the like. The fitness program may psychologically motivate the user to adopt new health and fitness habits by rewarding the user with a reward (e.g., a discounted higher level of a fitness regime).

There is thus provided in accordance with an embodiment of the present invention a method for operating a physical fitness program, including providing an animated database containing graphical images of a physical fitness program, at least some of the graphical images including animated characters, and creating a sequence of the graphical images in accordance with real-time interaction with a user as a function of user preferences and capabilities. Audio content may be created along with the sequence of graphical images. The sequence of the graphical images may be displayed on a display screen, or may be recorded on a recording medium.

In accordance with an embodiment of the present invention at least one of the sequence of the graphical images and the audio content may be interactively modified, such as but not limited to, choosing language of the audio content, music, animated characters, graphic settings and audio settings.

Further in accordance with an embodiment of the present invention the sequence of the graphical images is created by analyzing and taking into consideration at least one of user's health and fitness levels, individual preferences, habits, available equipment and goal.

Still further in accordance with an embodiment of the present invention how a physical fitness movement is accomplished correctly may be displayed. The physical fitness movement may be displayed with skeletal and muscle graphics.

In accordance with an embodiment of the present invention the audio content may include verbal instructions how the physical fitness movement is accomplished correctly.

Further in accordance with an embodiment of the present invention the method may include interactively evaluating performance of a user performing the physical fitness program. The evaluation may be based on monitoring and sensing with a biosensor.

Still further in accordance with an embodiment of the present invention the method may include psychologically motivating a user to adopt new health and fitness habits by rewarding the user with a reward.

### BRIEF DESCRIPTION OF THE DRAWINGS

The present invention will be understood and appreciated more fully from the following detailed description taken in conjunction with the drawings in which:

FIG. 1 is a simplified flowchart of creating a physical fitness program, in accordance with an embodiment of the present invention;

FIG. 2 is a simplified schematic illustration of an animated database containing graphical images for use in creating the physical fitness program, in accordance with an embodiment of the present invention;

FIG. 3 is a simplified illustration of a personal analyzer used to analyze personal data in creating the physical fitness program, in accordance with an embodiment of the present invention;

FIG. 4 is a simplified flowchart of a process used to analyze physical assessment and fitness goals, in accordance with an embodiment of the present invention;

FIG. 5 is a simplified schematic illustration of a display of a portion of the physical fitness program, in accordance with an embodiment of the present invention; and

FIG. 6 is a simplified schematic illustration of a display of skeletal and muscle graphics corresponding to the portion of the physical fitness program shown in FIG. 5, in accordance with an embodiment of the present invention.

### DETAILED DESCRIPTION OF THE PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general purpose computer selectively activated or reconfigured by a computer program stored in the computer. Such a computer program may be stored in a computer readable storage medium, such as but not limited to, any type of disk including floppy disks, optical disks, DVDs, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

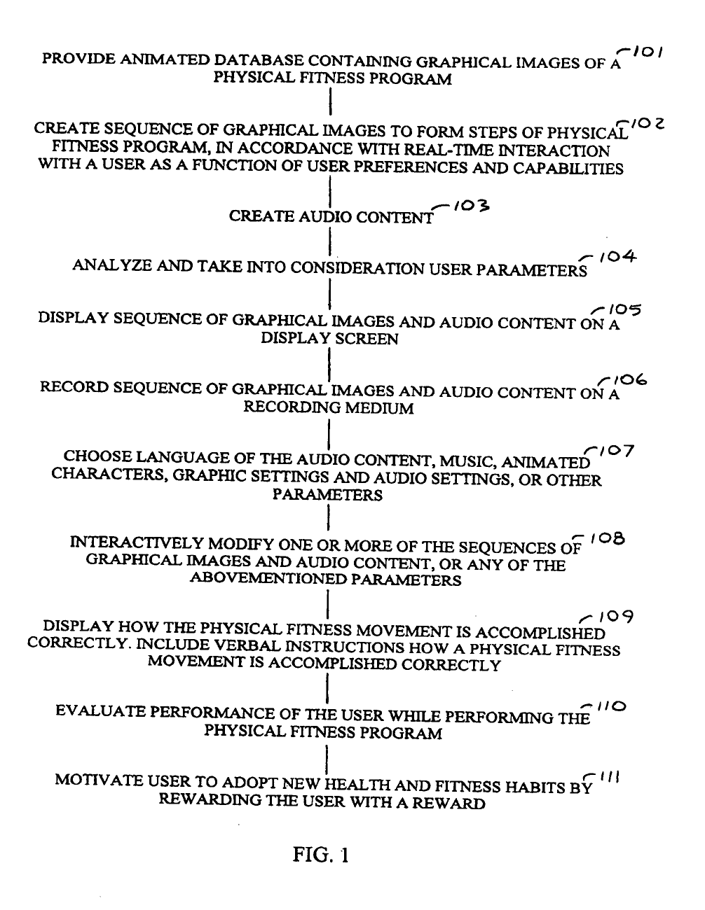

Reference is now made to FIG. 1, which illustrates a flowchart of creating a physical fitness program, in accordance with an embodiment of the present invention.

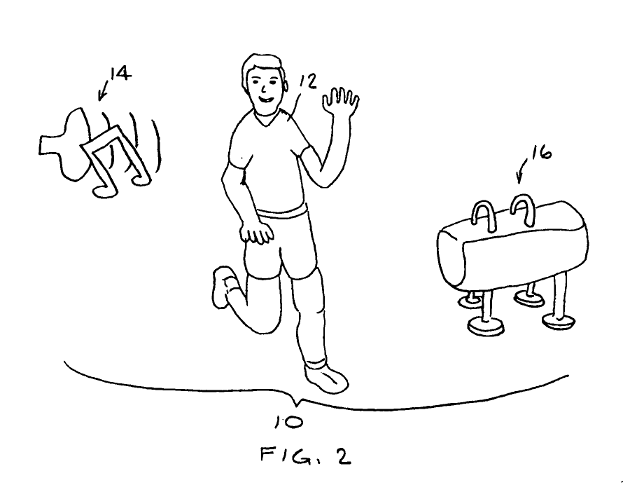

An animated database may be provided containing graphical images of a physical fitness program, wherein at least some of the graphical images comprise animated characters (reference numeral 101 in FIG. 1). An example of an animated database 10 is shown in FIG. 2. The animated database 10 may include one or more life-like characters 12, such as but not limited to, a human (e.g., a movie or sports star) or cartoon character (e.g., Bugs Bunny or other Looney tunes character, for example) and the like, choice of musical or other audio background accompaniment 14 (e.g., a choice of narrator voice and style, plus musical choices, such as, pop, rock, country, classic, gospel, instrumental, etc.), and background setting 16 (e.g., gym, football field, basketball court, living room, backyard, seashore, etc.).

A sequence of the graphical images may be created to form steps of the physical fitness program, in accordance with real-time interaction with a user as a function of user preferences and capabilities (reference numeral 102 in FIG. 1). The audio content may be created along with the sequence of graphical images, in synchronization or not in synchronization therewith, depending on user preference or depending on the situation (reference numeral 103 in FIG. 1). The sequence of the graphical images and audio culled from the animated database 10 may be created with graphic software and techniques, well known to those skilled in the art, which enable moving the character(s) in a vast number of real-time movements, such as is well known, for example, in interactive CDs (e.g., basketball, soccer or other sports CDs where the players move in accordance with user inputs, and an audio play-by-play is provided in accordance with the player movements).

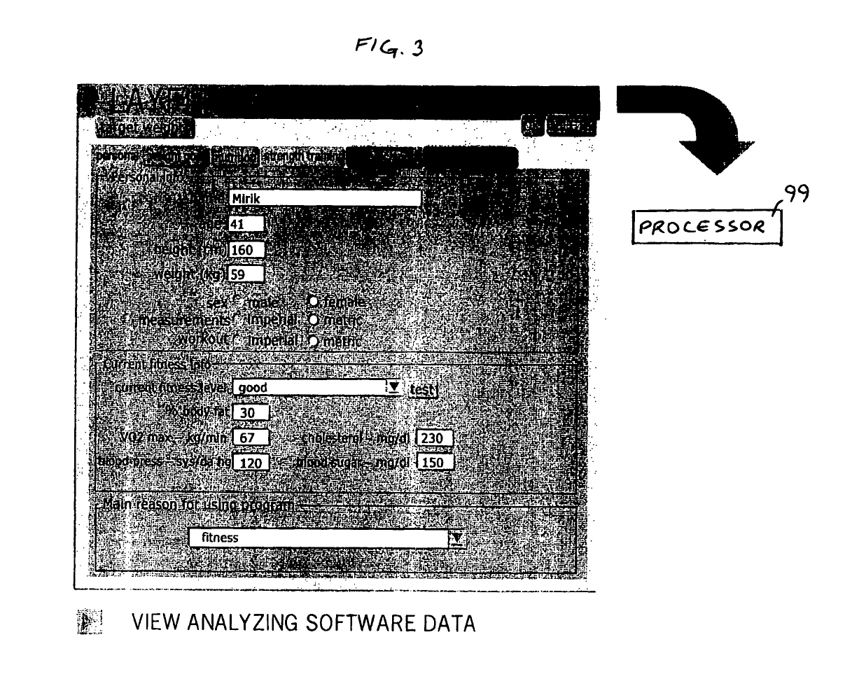

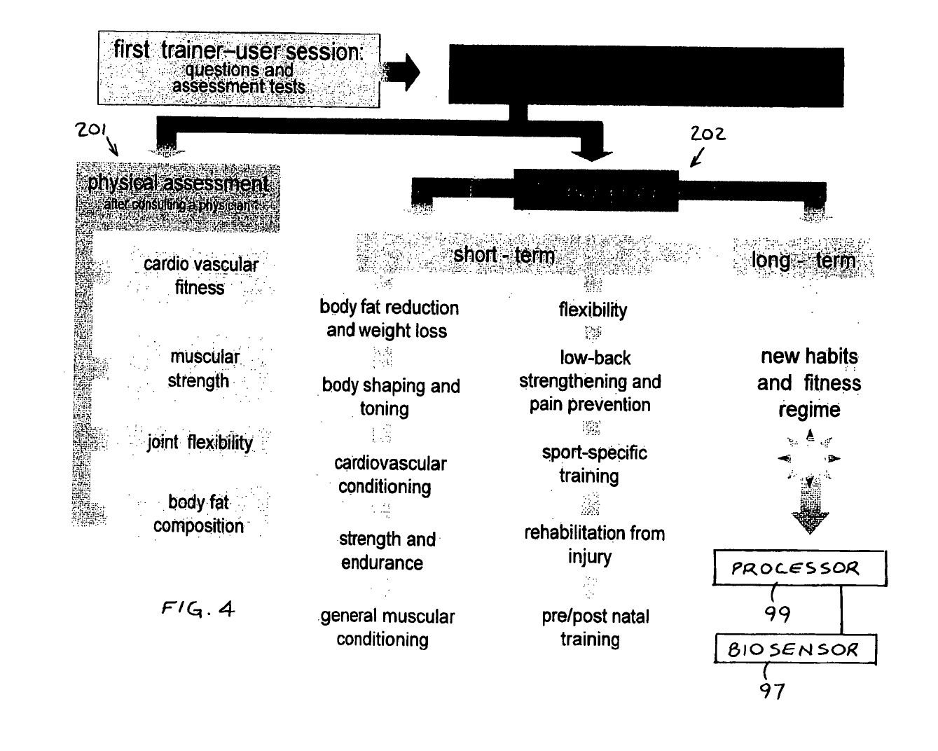

The sequence of graphical images and audio content may be created by analyzing and taking into consideration at least one of user's health and fitness levels, individual preferences, habits, available equipment and goals (reference numeral 104 in FIG. 1). Examples of such analysis are shown in FIGS. 3 and 4, which respectively illustrate non-limiting examples of a personal analyzer used to analyze personal data in creating the physical fitness program and of a flowchart of a process used to analyze physical assessment and fitness goals. It is emphasized that the invention is not limited to these examples.

Reference is now made to FIG. 3. The personal analyzer may be in the form of a window with places to fill in personal data, such as but not limited to, age, height, weight, percent body fat, cholesterol, etc. These data may be entered in a processor 99 for analysis and determination of an optimal physical fitness program, as is now described with reference to FIG. 4.

First, medical and personal data may be entered (reference number 201 in FIG. 4), such as but not limited to, cardiovascular fitness information, muscular strength, joint flexibility, body fat composition, etc. Personal goals may also be entered (reference number 202 in FIG. 4), such as but not limited to, short-term goals, for example, body fat reduction, body shaping, cardiovascular conditioning, strength and endurance, flexibility and others, and/or long term goals, such as but not limited to, new habits and/or fitness regime, exercise/rest habits and others.

The processor 99 may process all the data and determine an optimal physical fitness program. For example, for a male person, aged 45, height 175 cm, weight 80 kg, with only average muscular strength, and limited joint flexibility, whose short-term goal is body shaping and toning, and whose long-term goal is to maintain a weekly fitness regime, the analyzer (processor 99) may develop a fitness program of calisthenics, comprising a certain number of push-ups, sit-ups, jumping jacks, etc., combined with some aerobics.

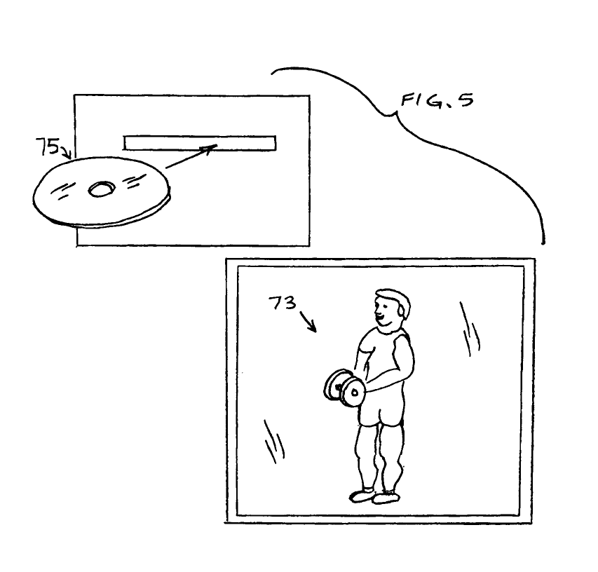

The optimal fitness program comprises a sequence of graphical images and audio content, which may be displayed on a display screen (reference numeral 105 in FIG. 1, and shown pictorially with reference numeral 73 in FIG. 5), such as but not limited to, a TV screen, PC screen, PDA, cell phone, game console, play station, and the like. Additionally or alternatively, the sequence of graphical images and audio content may be recorded on a recording medium, such as but not limited to, any type of disk including floppy disks, optical disks, DVDs, CDs, etc. (reference numeral 106 in FIG. 1, and shown pictorially with reference numeral 75 in FIG. 5).

The user may choose the language of the audio content, music, animated characters, graphic settings and audio settings, or other parameters (reference numeral 107 in FIG. 1). At any point, the user may interactively modify one or more of the sequences of graphical images and audio content, or any of the abovementioned parameters (reference numeral 108 in FIG. 1).

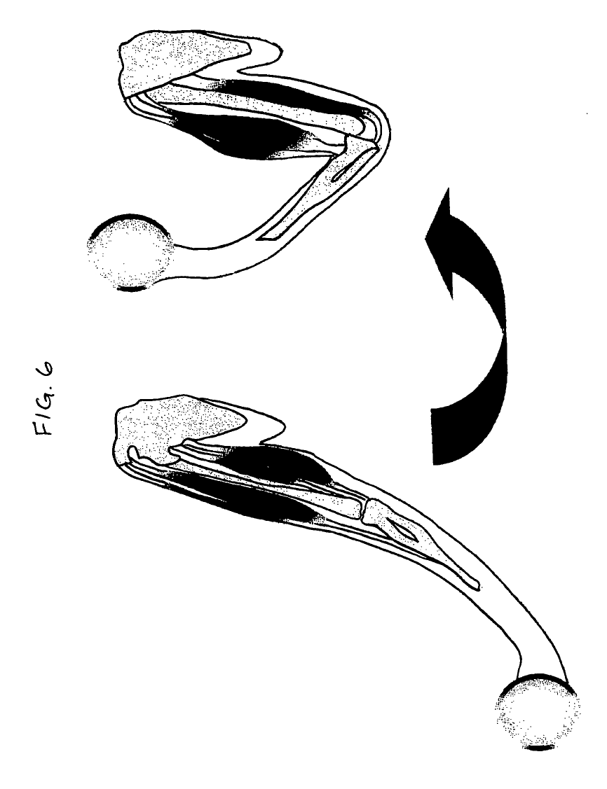

As seen respectively in FIGS. 5 and 6, the display may comprise how the physical fitness movement is accomplished correctly, and may use skeletal and muscle graphics in the display. The audio content may include verbal instructions how a physical fitness movement is accomplished correctly (reference numeral 109 in FIG. 1). For example, the display may show the character curling a dumbbell and announce “Grasp the dumbbell with your right hand, keep your elbow at your side, and lift the weight towards your shoulder. This exercises your biceps.”

The processor 99 may serve as an interactive home fitness evaluator and progress log recorder evaluate the performance of the user while performing the physical fitness program (reference numeral 110 in FIG. 1). The performance and progress of the user may be monitored with biosensors 97, such as but not limited to, pulse sensors, CO₂ sensors, blood pressure sensors and the like. The fitness program may psychologically motivate the user to adopt new health and fitness habits by rewarding the user with a reward, e.g., a discounted higher level of a fitness regime, (reference numeral 111 in FIG. 1).

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method for operating a physical fitness program, comprising:
providing an animated database containing graphical images of a physical fitness program, at least some of the graphical images comprising animated characters; and
creating a sequence of said graphical images in accordance with real-time interaction with a user as a function of user preferences and capabilities.

2. The method according to claim 1, further comprising creating audio content along with said sequence of graphical images.

3. The method according to claim 1, further comprising displaying the sequence of said graphical images on a display screen.

4. The method according to claim 1, further comprising recording the sequence of said graphical images on a recording medium.

5. The method according to claim 2, further comprising interactively modifying at least one of the sequence of said graphical images and the audio content.

6. The method according to claim 5, wherein the modifying comprises at least one of choosing language of the audio content, music, animated characters, graphic settings and audio settings.

7. The method according to claim 1, wherein the sequence of said graphical images is created by analyzing and taking into consideration at least one of user's health and fitness levels, individual preferences, habits, available equipment and goal.

8. The method according to claim 1, wherein the displaying the sequence of said graphical images comprises displaying how a physical fitness movement is accomplished correctly.

9. The method according to claim 8, wherein the physical fitness movement is displayed with skeletal and muscle graphics.

10. The method according to claim 2, wherein the audio content comprises verbal instructions how a physical fitness movement is accomplished correctly.

11. The method according to claim 1, further comprising interactively evaluating performance of a user performing the physical fitness program.

12. The method according to claim 11, wherein said evaluating is based on monitoring and sensing with a biosensor.

13. The method according to claim 1, further comprising psychologically motivating a user to adopt new health and fitness habits by rewarding the user with a reward.
